(19) United States
(12) Patent Application Publication
(10) Pub. No.: US 2026/0364416 A1
(43) Pub. Date: Nov. 19, 2026

(54) PULL-ROD GOLF BAG CART

(71) Applicant: Dongguan Yaoyu Plastic Hardware Products Co., Ltd., Dongguan (CN)

(72) Inventor: Zujie Zhang, Dongguan (CN)

(21) Appl. No.: 19/391,548

(22) Filed: Nov. 17, 2025

(30) Foreign Application Priority Data
May 16, 2025 (CN) 202520961122.0

(51) Int. Cl. A63B 55/60; B62B 5/06

(52) U.S. Cl. CPC A63B 55/60; B62B 5/067; B62B 2202/404; B62B 2301/14

(57) ABSTRACT

Disclosed is a pull-rod golf bag cart, including a frame, wheels disposed on the frame, and a pull rod disposed on the frame and extending upward. The frame includes a golf bag carrier. The pull rod includes a telescopic member and a fixed member. The fixed member is fixedly disposed on the frame, the telescopic member is inserted into the fixed member and is configured to telescope relative to the fixed member. A locking mechanism is provided between the fixed member and the telescopic member, and the locking mechanism is configured to maintain the relative position between the telescopic member and the fixed member. The present application integrates the advantages of conventional golf carts and telescopic pull rods, making the golf bag cart lighter, more effort-saving during movement, and adaptable to different course terrains.

### CROSS REFERENCE TO RELATED APPLICATIONS

The present disclosure claims the priority of Chinese Patent Application No. 2025209611220 filed on May 16, 2025 before CNIPA. All the above are hereby incorporated by reference in their entirety.

### TECHNICAL FIELD

The present disclosure relates to the field of leisure sports products, and specifically to a golf bag cart.

### BACKGROUND

A golf bag is a tool used in the sport of golf for carrying golf balls and clubs. To facilitate the transportation of the golf bag, a golf bag cart is employed. The golf bag cart includes a frame, wheels disposed on the frame, and a pull rod disposed on the frame and extending upward. The frame includes a golf bag carrier, and the golf bag is accommodated in the golf bag carrier. The user acts on the pull rod to push/pull the golf bag cart, thereby moving the golf bag.

### SUMMARY

The technical problem solved by the present disclosure: the pull rod of the golf bag cart may be hidden when not needed.

To solve the above technical problem, the present disclosure provides the following technical solution: a novel pull-rod golf bag cart, including a frame, wheels disposed on the frame, and a pull rod disposed on the frame and extending upward. The frame includes a golf bag carrier. The pull rod includes a telescopic member and a fixed member. The fixed member is fixedly disposed on the frame, the telescopic member is inserted into the fixed member and is configured to telescope relative to the fixed member. A locking mechanism is provided between the fixed member and the telescopic member, and the locking mechanism is configured to maintain the relative position between the telescopic member and the fixed member.

The golf bag is placed in the golf bag carrier. The user holds the telescopic member to push/pull the golf bag cart, thereby moving the golf bag. When movement of the golf bag cart is not needed, the user unlocks the locking mechanism and extends the telescopic member downward into the fixed member, thereby hiding the telescopic member. During use, the telescopic member is pulled out from the fixed member.

The frame includes a top frame. The top frame is located above the golf bag carrier, and the golf bag is accommodated between the golf bag carrier and the top frame. A top of the fixed member is fixed to the top frame, and a bottom of the fixed member is fixed to a back of the frame. The top frame is provided with a plurality of partition bars. The plurality of partition bars form club insertion ports, and the clubs are inserted into the golf bag through the club insertion ports. When pushing/pulling the golf bag cart, the telescopic member protrudes upward from the top frame; when not needed, the telescopic member is hidden in the fixed member, not hindering the user from accessing the clubs.

The top frame and the golf bag carrier are fixedly connected by a vertical panel. A bottom of the fixed member is installed on a pull rod base, and the pull rod base is configured to be fixedly installed on the vertical panel via a clamp plate. Alternatively, a plurality of parallel vertical panels are disposed between the top frame and the golf bag carrier, and the pull rod base and the connection seat described below are directly fixed to the vertical panels via threaded connectors.

The telescopic member includes a telescopic rod and a handle rod. A connecting rod is disposed within the telescopic rod. A guide member is provided at the bottom of the telescopic rod, and a vertical driving member and a horizontal locking block are movably engaged within the guide member. The horizontal locking block is connected to a return spring. The vertical driving member and the horizontal locking block are in contact via sloping surfaces. The top end of the connecting rod extends upward into the handle rod and abuts against an elastic telescopic assembly within the handle rod, while the bottom end of the connecting rod is connected to the vertical driving member. The fixed member is sleeve-shaped, and its side wall is provided with locking holes. The horizontal locking block is configured to engage with these locking holes.

When the user presses the elastic telescopic assembly, it pushes the connecting rod downward. The connecting rod drives the vertical driving member to move downward, and the sloping surface of the vertical driving member acts on the sloping surface of the horizontal locking block, causing the horizontal locking block to retract. The horizontal locking block compresses the return spring and disengages from the locking hole. At this point, the telescopic rod is configured to freely extend and retract within the fixed member, meaning the telescopic member may move freely relative to the fixed member. When the horizontal locking block aligns with a corresponding locking hole, the return spring's elastic force pushes the horizontal locking block into the locking hole, locking the relative position between the telescopic member and the fixed member.

A plurality of locking holes are provided, distributed along the length direction of the fixed member. Thus, multiple relative positions between the telescopic member and the fixed member may be achieved to suit different needs. As an option, the number of locking holes is three, meaning the length of the pull rod is configured to be adjusted to three different positions.

The elastic telescopic assembly includes an integrally formed button and an extension arm. The button cooperates with a vertical spring, which causes the button to protrude upward from the handle rod. The extension arm abuts against the top end of the connecting rod. When the user unlocks the locking mechanism between the telescopic member and the fixed member, they press the button downward, compressing the vertical spring. The extension arm pushes the connecting rod downward, unlocking the locking mechanism.

A connection seat is fixed to the back of the frame. The connection seat is connected to a tail support, which is equipped with a universal wheel. This allows the golf bag cart to turn flexibly. The wheels mounted on the golf bag carrier are wide large-diameter wheels, ensuring stable movement of the cart on grass.

The connection seat and the tail support are hinged via a hinge member. One end of the hinge member is equipped with a fastening member, which is connected to the hinge member via a fastening bolt. By adjusting the tightness of the fastening bolt, the friction between the connection seat and the tail support may be adjusted (i.e., the ease of rotation of the tail support relative to the connection seat). The user may choose to fixedly connect the tail support to the connection seat or allow movable connection according to their needs.

The present disclosure has the following technical effects:

First, this application integrates the advantages of conventional golf carts and telescopic pull rods. The pull rod replaces the traditional long handle/grip, making the golf bag cart lighter, more effort-saving during movement, and adaptable to different course terrains.

Second, when not needed, the pull rod may be retracted, which is aesthetically pleasing, space-saving, and does not hinder access to the golf clubs.

Third, the design of wide large-diameter wheels and universal wheels ensures stable and flexible movement of the cart on grass.

Fourth, the tightness of the connection between the tail support with the universal wheel and the main frame body is adjustable, meeting the needs of different users.

### BRIEF DESCRIPTION OF THE DRAWINGS

The following further explains the present disclosure in conjunction with the accompanying drawings:

FIG. 1 is a schematic diagram of the pull-rod golf bag cart.

FIG. 2 is a schematic diagram of the pull-rod golf bag cart viewed from above.

FIG. 3 is a schematic diagram of the pull-rod golf bag cart viewed from the front.

FIG. 4 is a schematic diagram when the pull rod 20 is retracted.

FIG. 5 is an exploded view of FIG. 1.

FIG. 6 is a schematic diagram of the pull rod, with partial enlargement.

FIG. 7 is a schematic diagram of the pull rod, with partial hidden and partial enlargement.

FIG. 8 is an exploded view of the pull rod, with partial enlargement.

### REFERENCE NUMERALS IN THE DRAWINGS

10: frame; 11: wheel; 12: golf bag carrier; 13: top frame; 14: connection seat; 15: tail support; 151: hinge member; 152: fastening member; 16: universal wheel; 17: pull rod base; 18: vertical panel;
20: pull rod; 201: telescopic member; 202: fixed member; 21: telescopic rod; 22: handle rod; 23: connecting rod; 24: guide member; 25: vertical driving member; 26: horizontal locking block; 261: return spring; 27: elastic telescopic assembly; 271: button; 272: extension arm; 273: vertical spring; 28: locking hole.

### DETAILED DESCRIPTION

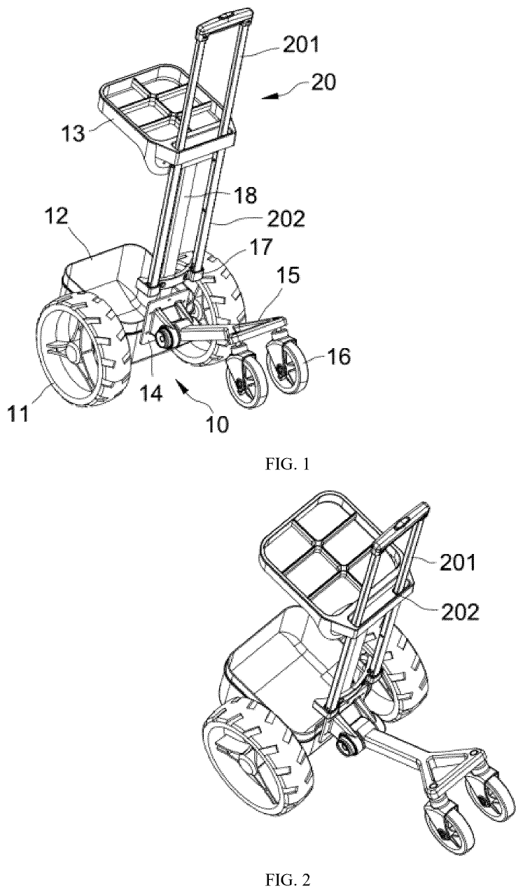

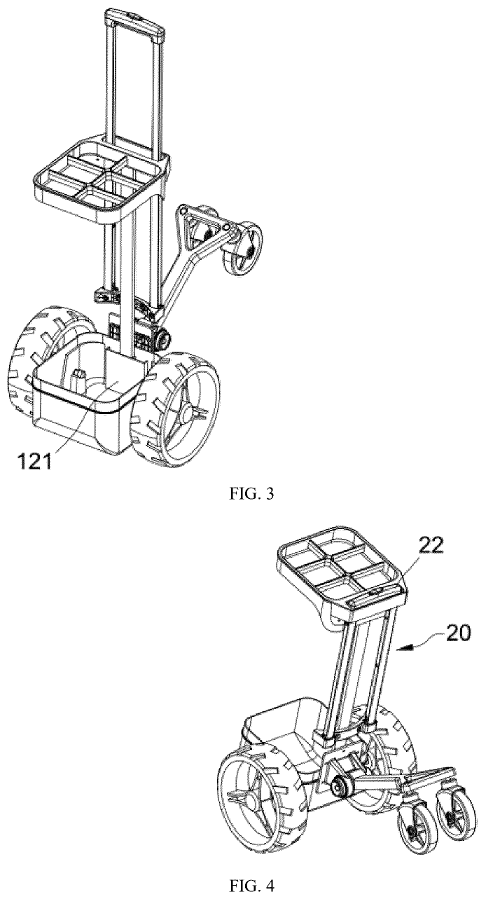

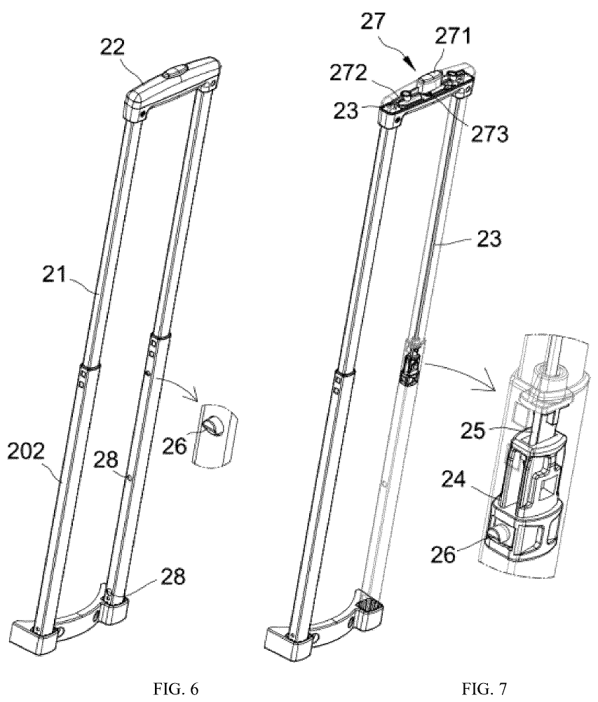

With reference to FIGS. 1 and 6, a pull-rod golf bag cart includes a frame 10, wheels 11 disposed on the frame, and a pull rod 20 disposed on the frame and extending upward. The frame includes a golf bag carrier 12. The pull rod includes a telescopic member 201 and a fixed member 202. The fixed member is fixedly disposed on the frame, the telescopic member is inserted into the fixed member and is configured to telescope relative to the fixed member. A locking mechanism is provided between the fixed member and the telescopic member, and the locking mechanism is configured to maintain the relative position between the telescopic member and the fixed member.

As shown in FIG. 1, the frame 10 includes a top frame 13. The top frame is located above the golf bag carrier 12, and a golf bag is accommodated between the golf bag carrier and the top frame. A top of the fixed member 202 is fixed to the top frame, and a bottom of the fixed member is fixed to a back of the frame.

With reference to FIGS. 6 to 8, the telescopic member 201 includes a telescopic rod 21 and a handle rod 22. A connecting rod 23 is disposed within the telescopic rod. A guide member 24 is provided at a bottom of the telescopic rod, and a vertical driving member 25 and a horizontal locking block 26 are movably engaged within the guide member. The horizontal locking block is connected to a return spring 261. The vertical driving member and the horizontal locking block are in contact via sloping surfaces. A top end of the connecting rod extends upward into the handle rod and abuts against an elastic telescopic assembly 27 within the handle rod, and a bottom end of the connecting rod is connected to the vertical driving member 25.

The fixed member 202 is sleeve-shaped, and a side wall of the fixed member is provided with locking holes 28. The horizontal locking block 26 is configured to engage with the locking holes.

A plurality of locking holes 28 are provided, and the plurality of locking holes are distributed along a length direction of the fixed member 202.

As shown in FIG. 7, the elastic telescopic assembly 27 includes an integrally formed button 271 and an extension arm 272. The button cooperates with a vertical spring 273, and the vertical spring causes the button to protrude upward from the handle rod 22. The extension arm abuts against the top end of the connecting rod 23.

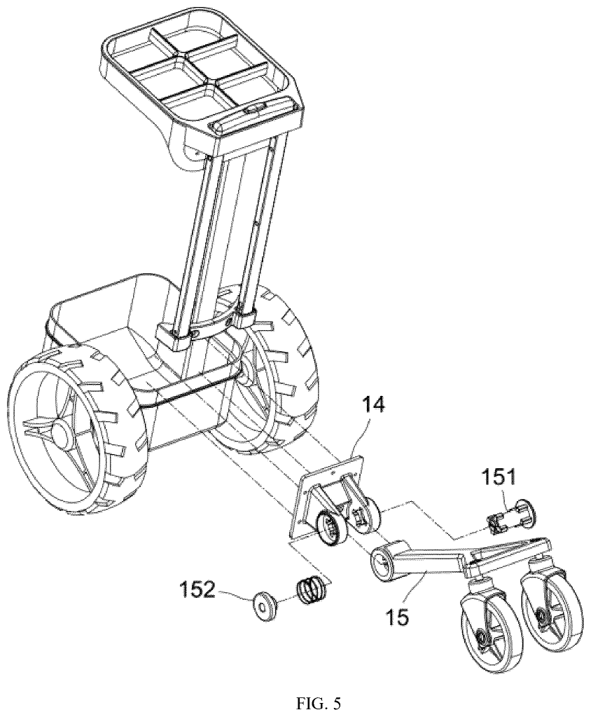

As shown in FIGS. 1 and 5, a connection seat 14 is fixed to a back of the frame 10. The connection seat is connected to a tail support 15, and the tail support is provided with a universal wheel 16.

The connection seat 14 is hinged to the tail support 15 via a hinge member 151. One end of the hinge member is equipped with a fastening member 152, and the fastening member is connected to the hinge member via a fastening bolt.

The golf bag is placed in the golf bag carrier 12, located below the top frame 13. The user holds the telescopic member 201 to push/pull the golf bag cart, thereby moving the golf bag. When movement of the golf bag cart is not needed, the user unlocks the locking mechanism and extends the telescopic member 201 downward into the fixed member 202, thereby hiding the telescopic member. During use, the telescopic member 201 is pulled out from the fixed member 202.

The top frame 13 is provided with a plurality of partition bars. The plurality of partition bars form club insertion ports, and the clubs are inserted into the golf bag through the club insertion ports. When pushing/pulling the golf bag cart, the telescopic member 201 protrudes upward from the top frame 13; when not needed, the telescopic member 201 is hidden in the fixed member 202, not hindering the user from accessing the clubs.

The top frame 13 and the golf bag carrier 12 are fixedly connected by a vertical panel 18. A bottom of the fixed member 202 is installed on a pull rod base 17, and the pull rod base is configured to be fixedly installed on the vertical panel 18 of the frame via a clamp plate. Alternatively, a plurality of parallel vertical panels 18 are disposed between the top frame 13 and the golf bag carrier 12, and the pull rod base 17 and the connection seat 14 are directly fixed to the vertical panels 18 via threaded connectors.

The user presses the button 271 of the elastic telescopic assembly 27, causing the extension arm 272 to push the connecting rod 23 downward. The connecting rod drives the vertical driving member 25 to move downward, and the sloping surface of the vertical driving member acts on the sloping surface of the horizontal locking block, causing the horizontal locking block 26 to retract. The horizontal locking block compresses the return spring 261 and disengages from the locking hole 28. At this point, the telescopic rod 21 may freely extend and retract within the fixed member 202, meaning the telescopic member 201 may move freely relative to the fixed member. When the horizontal locking block 26 aligns with a corresponding locking hole 28, the elastic force of the return spring 261 pushes the horizontal locking block into the locking hole, locking the relative position between the telescopic member 201 and the fixed member 202.

The number of locking holes 28 is three, meaning the length of the pull rod 20 may be adjusted to three different positions.

The tightness of the connection between the tail support 15 with the universal wheel 16 and the connection seat 14 is adjusted via the fastening bolt. The user may choose to fixedly connect the tail support 15 to the connection seat 14 or allow movable connection according to their needs.

The above content is only a preferred embodiment of the present disclosure. For those skilled in the art, based on the ideas of the present disclosure, there will be changes in specific embodiments and scope of application. The content of this specification should not be construed as limiting the present disclosure.

What is claimed is:

1. A pull-rod golf bag cart, comprising a frame, wheels disposed on the frame, and a pull rod disposed on the frame and extending upward, the frame comprising a golf bag carrier, wherein the pull rod comprises a telescopic member and a fixed member, the fixed member is fixedly disposed on the frame, the telescopic member is inserted into the fixed member and is configured to telescope relative to the fixed member, a locking mechanism is provided between the fixed member and the telescopic member, and the locking mechanism is configured to maintain a relative position between the telescopic member and the fixed member.

2. The pull-rod golf bag cart according to claim 1, wherein the frame comprises a top frame, the top frame is located above the golf bag carrier, a golf bag is accommodated between the golf bag carrier and the top frame, a top of the fixed member is fixed to the top frame, and a bottom of the fixed member is fixed to a back of the frame.

3. The pull-rod golf bag cart according to claim 1, wherein the telescopic member comprises a telescopic rod and a handle rod, a connecting rod is disposed in the telescopic rod, a guide member is disposed at a bottom of the telescopic rod, a vertical driving member and a horizontal locking block are movably engaged in the guide member, the horizontal locking block is connected to a return spring, the vertical driving member and the horizontal locking block are in contact via a sloping surface, a top end of the connecting rod extends upward into the handle rod and abuts against an elastic telescopic assembly in the handle rod, and a bottom end of the connecting rod is connected to the vertical driving member;
the fixed member is sleeve-shaped, a side wall of the fixed member is provided with a locking hole, and the horizontal locking block is configured to engage with the locking hole.

4. The pull-rod golf bag cart according to claim 3, wherein a plurality of locking holes are provided, and the plurality of locking holes are distributed along a length direction of the fixed member.

5. The pull-rod golf bag cart according to claim 3, wherein the elastic telescopic assembly comprises an integrally formed button and an extension arm, the button cooperates with a vertical spring, the vertical spring causes the button to protrude upward from the handle rod, and the extension arm abuts against the top end of the connecting rod.

6. The pull-rod golf bag cart according to claim 1, wherein a connection seat is fixed to a back of the frame, the connection seat is connected to a tail support, and the tail support is provided with a universal wheel.

7. The pull-rod golf bag cart according to claim 6, wherein the connection seat is hinged to the tail support via a hinge member, one end of the hinge member is equipped with a fastening member, and the fastening member is connected to the hinge member via a fastening bolt.
